(19) United States
(12) Patent Application Publication
(10) Pub. No.: US 2016/0313559 A1
(43) Pub. Date: Oct. 27, 2016

(54) METHOD FOR MANUFACTURING DIFFRACTIVE OPTIC ELEMENT AND IMAGE DISPLAY DEVICE

(71) Applicant: Seiko Epson Corporation, Tokyo (JP)

(72) Inventor: Fumika Yamada, Matsumoto-shi (JP)

(21) Appl. No.: 15/099,775

(22) Filed: Apr. 15, 2016

(30) Foreign Application Priority Data
Apr. 24, 2015 (JP) 2015-089289

(51) Int. Cl. G02B 27/01; G03H 1/12; G03H 1/04

(52) U.S. Cl. CPC G02B 27/0172; G03H 1/0402; G03H 1/12; G03H 2001/0439; G02B 2027/0174; G02B 2027/0134

(57) ABSTRACT

A method for manufacturing a diffractive optic element by exposing hologram recording material includes exposure processing that divides a coherent beam radiated from one beam source into an object beam and a reference beam, and irradiates the hologram recording material with an exposure beam by interfering the object beam with the reference beam. In the exposure processing, an optic element, which adjusts beam intensity distribution of the exposure beam with which the hologram recording material is irradiated, is arranged in a path of one or both of the object beam and the reference beam.

### BACKGROUND

1. Technical Field

The present invention relates to a method for manufacturing a diffractive optic element and an image display device.

2. Related Art

In recent years, an image display device of a mounting type such as a head mounted display (HDM) or the like has been noted. HDM, which is a structure that guides an image beam to an observer's eyes, uses a hologram that deflects the image beam by diffracting the image beam in a direction different from an incident direction.

The hologram is the diffractive optic element using a diffraction phenomenon different from that of an optic element such as normal mirrors and lenses that use regular reflection and refraction. In addition, the hologram has characteristics that the degree of freedom of operation is high in an advancing direction of the beam. A volume hologram has high diffraction efficiency among the characteristics because only a first-order diffracted beam where Bragg's condition is satisfied is generated, without generating higher order diffracted beams appearing in the other diffractive optic elements such as a surface relief type element.

An exposure device that branches lens beams generated from one lens beam source and irradiates a hologram recording material with a plurality of beams at the same time is used in the manufacture of the diffractive optic element (for example, see Japanese Patent No. 5471775).

However, a part where beam intensity is locally strong is generated in a structure of an exposure optical system of the exposure device described above. In this case, reaction non-uniformity is generated within a plane during reaction processing of the hologram recording material. For example, in material such as a photo polymer, variation in diffraction efficiency distribution within the plane is generated due to variation of volume of the material generated from the reaction processing is locally processed.

### SUMMARY

An advantage of some aspects of the invention is to provide a method for manufacturing a diffractive optic element and an image display device in which diffraction efficiency distribution within a plane is uniformly processed.

According to an aspect of the invention, there is provided a method for manufacturing the diffractive optic element by exposing hologram recording material, the method includes exposure processing that divides a coherent beam radiated from a beam source into an object beam and a reference beam, and irradiates the hologram recording material with an exposure beam by interfering the object beam with the reference beam. In the exposure processing, an optic element, which adjusts beam intensity distribution of the exposure beam with which the hologram recording material is irradiated, is arranged in a path of the object beam or the reference beam.

In this case, it is possible to manufacture the diffractive optic element in which the diffraction efficiency distribution is uniformly processed within a plane by uniformly proceeding the beam intensity distribution of the exposure beam with which the hologram recording material is irradiated using the optic element.

In the method for manufacturing the diffractive optic element, a neutral density filter may be used as the optic element.

In this case, it is possible to uniformly proceed the beam intensity distribution of the exposure beam with which the hologram recording material is irradiated by using the neutral density filter.

In the method for manufacturing the diffractive optic element, a spatial beam modulator may be used as the optic element.

In this case, it is possible to uniformly proceed the beam intensity distribution of the exposure beam with which the hologram recording material is irradiated by using the spatial beam modulator.

In the method for manufacturing a diffractive optic element, in the exposure processing, the spatial beam modulator may be arranged in a path of one side of the object beam and the reference beam, and a polarization element may be arranged in the path of the other side.

In this case, it is possible to align a polarization direction of the exposure beam with which the hologram recording material is irradiated by using the spatial beam modulator and the polarization element.

In the method for manufacturing a diffractive optic element, in the exposure processing, an exposure region of the hologram recording material may be divided into a plurality of regions, and the exposure may be performed to each of the plurality of regions.

In this case, it is possible to manufacture the diffractive optic element on which the diffraction efficiency distribution uniformly proceeds within a plane because an exposure condition is adjusted on every divided exposure region according to the beam intensity distribution of the exposure beam.

In the method for manufacturing a diffractive optic element, in the exposure processing, an exposure region except a region where the exposure is selected among the plurality of regions may be blocked.

In this case, it is possible to prevent the exposure region except a region in which the exposure is selected from being irradiated with the exposure beam.

According to another aspect of the embodiment, there is provided a method for manufacturing a diffractive optic element by exposing hologram recording material, the method includes exposure processing that divides a coherent beam radiated from a beam source into an object beam and a reference beam, and irradiates the hologram recording material with an exposure beam by interfering the object beam with the reference beam. In the exposure processing, the hologram recording material exposed by the exposure beam is divided into a plurality of regions, and the exposure is performed to each of the plurality of regions.

In this case, it is possible to manufacture the diffractive optic element on which the diffraction efficiency distribution uniformly proceeds the diffraction efficiency distribution within a plane because an exposure condition is adjusted on every divided exposure region according to the beam intensity distribution of the exposure beam.

In the method for manufacturing the diffractive optic element, in the exposure processing, an exposure region except a region where the exposure is selected among the plurality of regions may be blocked.

In this case, it is possible to prevent the exposure region except a region in which the exposure is selected from being irradiated with the exposure beam.

According to still another aspect of the embodiment, there is provided an image display device including an image beam generation unit that generates an image beam; and a diffractive optic element that deflects toward eyes of a user at least a part of the image beam. The diffractive optic element uses the diffractive optic element manufactured by using the method for manufacturing the diffractive optic element according to the aspects.

In this case, it is possible to perform highly accurate image display by using the diffractive optic element in which the diffraction efficiency distribution is uniformly processed within a plane.

### BRIEF DESCRIPTION OF THE DRAWINGS

The disclosure will be described with reference to the accompanying drawings, wherein like numbers reference like elements.

FIG. 1 is a perspective view illustrating utilization of HDM according to an embodiment.

FIG. 2 is a perspective view illustrating a configuration of HDM illustrated in FIG. 1.

FIG. 3 is a schematic diagram illustrating a configuration of a display device including HDM illustrated in FIG. 1.

FIG. 4 is a schematic diagram illustrating a configuration of an exposure device used in the method for manufacturing a diffractive optic element according to a first embodiment.

FIG. 5 is a graph illustrating the amount of volume variation with respect to exposure time of a hologram recording material.

FIG. 6 is a schematic diagram for describing variations associated with exposure of the hologram recording material.

FIG. 7 is a graph illustrating an OD value distribution of an ND filter illustrated in FIG. 4.

FIGS. 8A and 8B are graphs illustrating beam intensity distribution of an exposure beam before and after arrangement of the ND filter.

FIG. 9 is a schematic diagram for describing variations associated with exposure of a hologram recording material in a method for manufacturing the diffractive optic element according to a second embodiment.

FIG. 10 is a schematic diagram for describing variations associated with the exposure of a hologram recording material in a method for manufacturing the diffractive optic element according to a third embodiment.

FIGS. 11A and 11B are planar diagrams illustrating an example of a beam blocking plate.

FIG. 12 is a plane diagram for describing division exposure by using a beam blocking plate illustrated in FIGS. 11A and 11B.

FIGS. 13A and 13B are planar diagrams illustrating another example of the beam blocking plate.

FIGS. 14A and 14B are planar diagrams illustrating another example of the beam blocking plate.

FIG. 15 is a schematic diagram for describing variations associated with the exposure of a hologram recording material in a method for manufacturing the diffractive optic element according to a fourth embodiment.

FIG. 16 is a schematic diagram for describing variations associated with the exposure of a hologram recording material in a method for manufacturing the diffractive optic element according to a fifth embodiment.

FIGS. 17A to 17C are planar diagrams illustrating another example of the beam blocking plate.

### DESCRIPTION OF EXEMPLARY EMBODIMENTS

Hereinafter, an embodiment will be described in detail with reference to the drawings.

In addition, the disclosure is not limited to the following embodiments, and can be implemented with modification as appropriate within a scope without changing the gist thereof. In addition, there is case that schematically illustrates components in the drawings for clarity of the respective components used in the following description, and the scale of dimensions by the components may be differently illustrated.

### Image Display Device

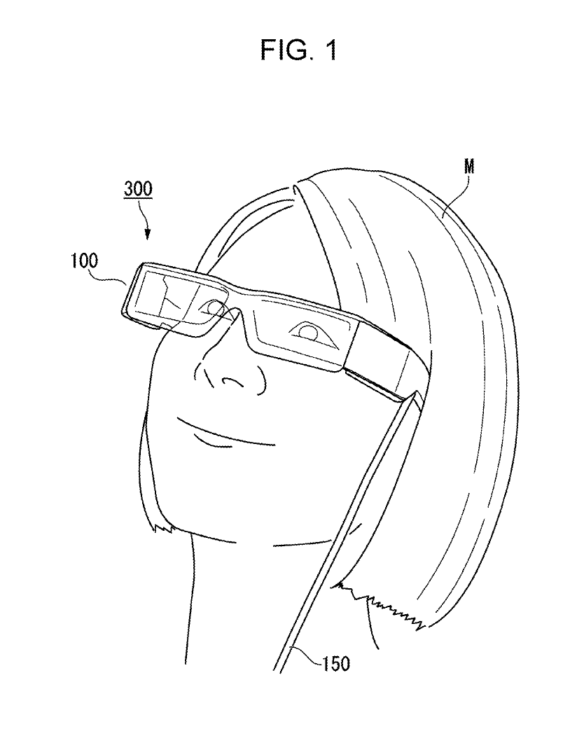

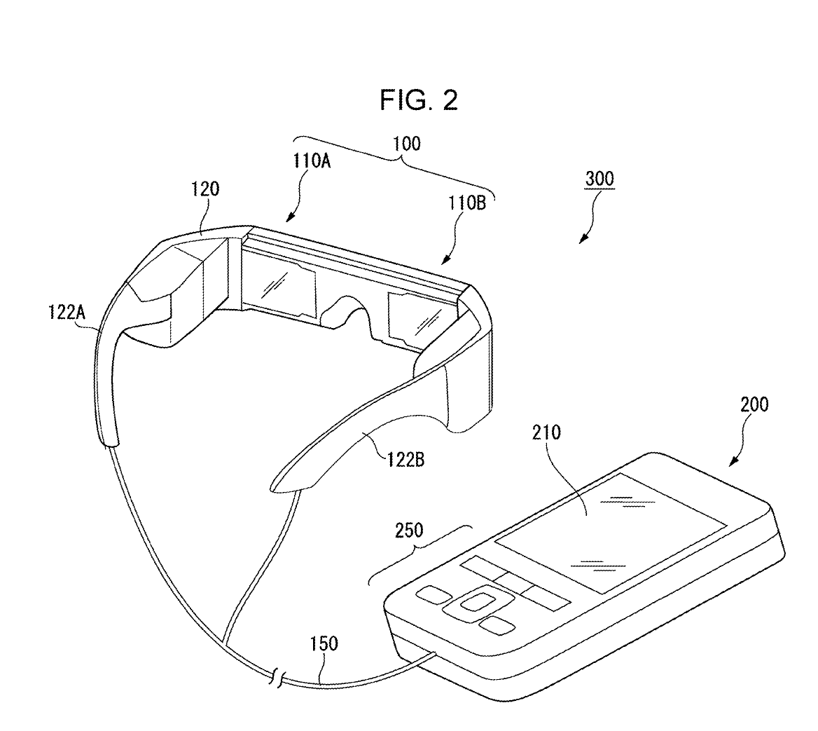

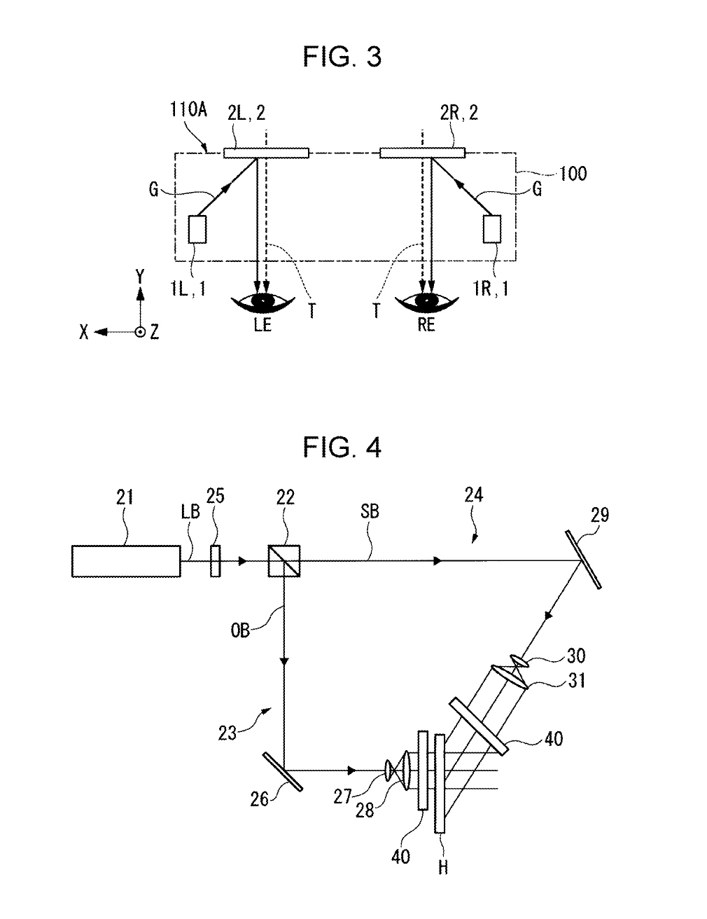

First, as the image display device according to an embodiment, a head mounted display (hereinafter, referred to as HDM) 300 described in FIG. 1, FIG. 2, and FIG. 3 will be described. FIG. 1 is a perspective view illustrating a use example of the HDM 300. FIG. 2 is a perspective view illustrating of a configuration of the HDM 300. FIG. 3 is a schematic diagram illustrating a configuration of a display device 100 including the HDM 300.

The HDM 300 in the embodiment, as illustrated in FIG. 1, is a device which a user M wears on his head such as glasses. The HDM 300, as illustrated in FIG. 2, includes a display device (display glass) 100 having the form of glasses, and a control device (controller) 200 of a size which can be held by the hands of the user M.

The display device 100 and the control device 200 are communicatively connected to each other in a wired or wireless state. In the embodiment, a left eye image display unit 110A and a right eye image display unit 110B constituting the display device 100 are connected to the control device 200 in a wired state through a cable 150, and exchange image signals, control signals, or the like with the control device 200.

The display device 100 includes a glasses frame (device body) 120, the left eye image display unit 110A, and the right eye image display unit 110B. The left eye image display unit 110A and the right eye image display unit 110B are supported by the glasses frame 120. The glasses frame 120 includes a pair of temples 122A and 122B so as to be worn on the ears of the user M.

The control device 200 includes a display unit 210 and an operation unit 250. The display unit 210 displays, for example, a variety of information, instructions, or the like for the user M. The operation unit 250 is configured with buttons or the like for instructing a variety of operations. In addition, the operation unit 250 may be a touch panel, or the like integrated with the display unit 210.

The HDM 300 of the embodiment, as illustrated in FIG. 3, is a see-through type (passing through type), can view images (image beam G illustrated by dashed line in FIG. 3) reflected and displayed at the left eye image display unit 110A and the right eye image display unit 110B, and can view images (external beam T illustrated by dashed line in FIG. 3) of the outside world passing through the left eye image display unit 110A and the right eye image display unit 110B at the same time.

The left eye image display unit 110A includes a left diffractive optic element 2L, and a left eye image beam generation unit 1L, corresponding to a left eye LE of the user M. Similarly, the right eye image display unit 110B includes a right eye diffractive optic element 2R, and a right eye image beam generation unit 1R, corresponding to a right eye RE of the user M.

The image beam generation unit 1L emits an image beam G toward a diffractive optic element 2L. An external beam T that is passed through the diffractive optic element 2L is incident on the left eye LE of the user M, the image beam G from the image beam generation unit 1L is reflected in the diffractive optic element 2L, and, at the same time, the reflected image beam G is condensed to the left eye LE of the user M.

Similarly, the image beam generation unit 1R emits the image beam G toward a diffractive optic element 2R. The external beam T that is passed through in the diffractive optic element 2R is incident on the right eye RE of the user M, the image beam G from the image beam generation unit 1R is reflected in the diffractive optic element 2R, and, at the same time, the reflected image beam G is condensed to the right eye RE of the user M.

Accordingly, it is possible for the user M to visually recognize images (image beam G) displayed by the image beam generation unit 1L and the image beam generation unit 1R through the diffractive optic element 2L and the diffractive optic element 2R, and, at the same time, the image (external beam T) of the external world passed through the diffractive optic element 2L and the diffractive optic element 2R.

In addition, it is possible for the user M to recognize (visually recognition) a three-dimensional appearance (3D images) of a displayed image by displaying stereoscopic images (image for the right eye and image for the left eye) in which mutual parallax is applied in the image beam generation unit 1L and the image beam generation unit 1R.

Furthermore, since the left eye image display unit 110A and the right eye image display unit 110B display images for the right eye and the left eye, configurations of the left eye image display unit 110A and the right eye image display unit 110B are the same. Accordingly, hereinafter, the image beam generation unit 1L and the image beam generation unit 1R are dealt as an image beam generation unit 1, and the diffractive optic element 2L and the diffractive optic element 2R are dealt as a diffractive optic element 2, if necessary.

In the HDM 300 of the embodiment, it is possible to perform highly accurate image display by using the diffractive optic element 2 where diffraction efficiency distribution is uniformly processed within a plane.

### Method for Manufacturing Diffractive Optic Element (First Embodiment)

Next, a method for manufacturing the diffractive optic element 2 according to a first embodiment will be described with respect to FIG. 4. In addition, FIG. 4 is a schematic diagram illustrating a configuration of an exposure device used in the first embodiment.

The method for manufacturing the diffractive optic element 2 according to the first embodiment includes exposure processing that exposes a hologram recording material H that is the diffractive optic element 2 by using the exposure device illustrated in FIG. 4.

The exposure device illustrated in FIG. 4 includes a laser beam source (beam source) 21 that emits a laser beam LB that is an exposure beam, a beam splitter (beam splitting element) 22 that divides the laser beam LB into an object beam OB and a reference beam SB, a first exposure optical system 23 that irradiates the object beam OB from one side of the hologram recording material H, and a second exposure optical system 24 that irradiates the reference beam SB from the other surface side of the hologram recording material H.

The laser beam source 21 emits a laser beam LB that is a coherent beam toward the beam splitter 22. In addition, a shutter 25 is arranged in a beam path between the laser beam source 21 and the beam splitter 22. The shutter 25 switches passing and blocking of the laser beam LB.

The beam splitter 22 reflects the object beam OB in incident laser beam LB toward the first exposure optical system 23, and allows the reference beam SB to pass toward the second exposure optical system 24. In addition, as a beam splitting element, a polarization beam splitter can be used instead of the beam splitter 22, In a case where the polarization beam splitter is used, it is possible to adjust an intensity ratio of, for example, the reference beam SB in combination with a ½ wavelength (λ) plate.

The first exposure optical system 23 includes a first mirror 26 that bends a beam path of the object beam OB, a first objective mirror 27 that condenses the object beam OB, and a first collimator lens 28 that makes the condensed object beam OB a parallel beam. The first exposure optical system 23 approximately and vertically irradiates one surface of the hologram recording material H with the object beam OB.

The second exposure optical system 24 includes a second mirror 29 that bends a beam path of the reference beam SB, a second objective lens 30 that condenses the reference beam SB, and a second collimator lens 31 that makes the condensed object beam OB parallel beams. The second exposure optical system 24 irradiates the other surface of the hologram recording material H with the reference beam SB in an oblique direction.

In the exposure device having the configuration described above, a beam is radiated at the same time in a direction different from that of the object beam OB and the reference beam SB with respect to the hologram recording material H. At this time, interference fringes are generated in the exposure beam where the object beam OB and the reference beam SB interfere with each other. It is possible to obtain the diffractive optic element 2 by recording the interference fringes on the hologram recording material H.

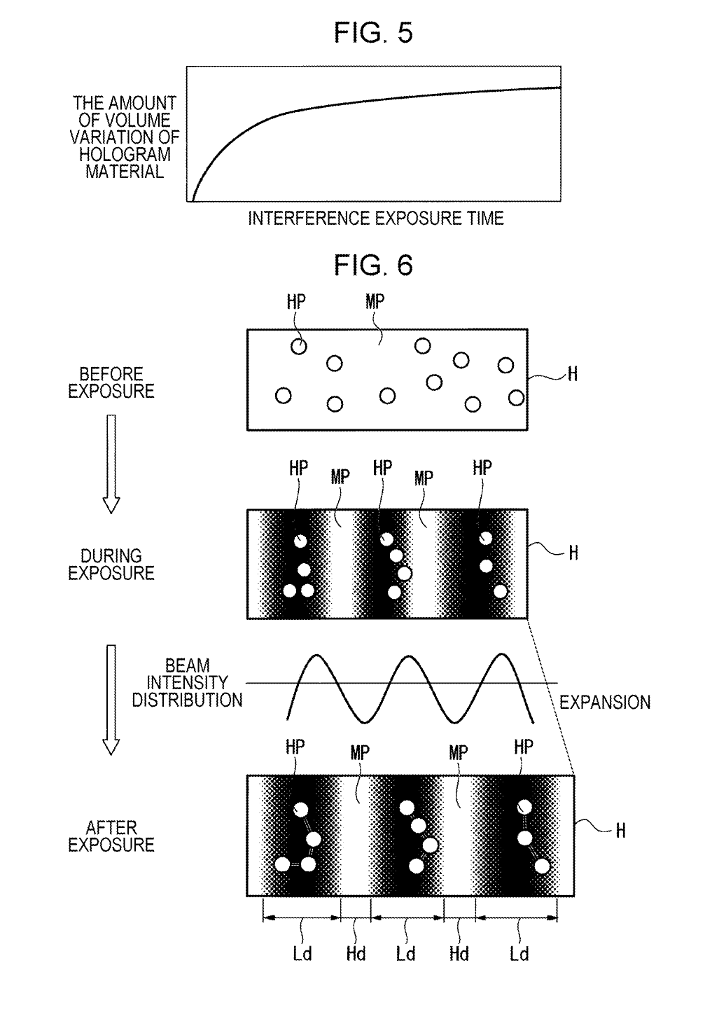

Here, variations associated with the exposure of the hologram recording material H will be described with reference to FIG. 5 and FIG. 6. In addition, FIG. 5 is a graph illustrating the amount of volume variation with respect to the exposure time of the hologram recording material H. In addition, the upper part of FIG. 6 is a schematic diagram illustrating a state before the exposure of the hologram recording material H. The middle part of FIG. 6 is a schematic diagram illustrating a state during the exposure of the hologram recording material H. The lower part of FIG. 6 is a schematic diagram illustrating a state after the exposure of the hologram recording material H.

The hologram recording material H before the exposure, as illustrated in the upper part of FIG. 6, is a photopolymer in which high refractive index monomer HP is dispersed in a matrix resin MP. In the exposure processing using the exposure device illustrated in FIG. 4, reaction of a hologram material H starts, as illustrated in the middle part of FIG. 6, according to beam intensity distribution of the exposure beam generated by interference between the object beam OB and the reference beam SB, when the exposure starts while the shutter 25 is open. In a case of the photopolymer, the monomer HP is polymerized through the polymerization reaction.

The volume of the hologram material H, as illustrated in FIG. 5, is varied in accordance with reaction in the exposure. In addition, a case where the hologram recording material H is expanded in accordance with reaction in the exposure is described as an example in the embodiment. However, there is a case where the hologram recording material H is contracted. In addition, since volume contraction is generated in some photopolymer during hologram fixing processing, measures such as utilization of a monomer material illustrating expansibility are required during the reaction of the interference exposure so as to cancel the contraction.

In addition, it is ideal that the reaction is uniformly processed on the overall surface of the hologram recording material H in the exposure processing. However, intensity non-uniformity is generated by the beam intensity distribution of the exposure beam and an incident angle of the exposure beam with respect to the hologram recording material H.

Therefore, since the reaction of high refractive index monomer HP is processed on a region in which beam intensity, which is strong, of the exposure beam with which the photopolymer is irradiated on the hologram recording material H rather than on a region in which the beam intensity thereof is weak, volume variation is locally generated.

In the hologram recording material H, in a case where the volume variation is generated during the exposure, variation or the like, is generated in materials. However, an interval and an angle of the interference fringes that are previously recorded are varied, and new interference fringes are recorded, at the same time. Therefore, the interference fringes by the hologram that are produced, and a plurality of interference fringes are overlapped rather than a single type and are in a multiple exposure state.

As a result, in the hologram recording material H after the exposure, as illustrated in the lower part of FIG. 6, interference fringes, which are configured with a region Ld having a high refractive index and a region Hd having a low refractive index, are formed in a lower diffraction efficiency on a region in which the beam intensity of the exposure beam is strong.

Accordingly, variation in the diffraction efficiency distribution is generated within a plane by locally proceeding volume variation generated in the reaction processing in the hologram recording material H. In addition, there is a possibility that the temperature is increased by incidence of the exposure beam on the hologram recording material H. In addition, there are problems that the hologram recording material H is thermally expanded, and further the diffraction efficiency distribution is non-uniform within a plane in the hologram recording material H.

For example, in a case where the beam intensity of the laser beam LB emitted from the laser beam source 21 has Gaussian distribution, the beam intensity in the vicinity of a center of the exposure beam is maximized, and the beam intensity decreases, as the beam intensity moves toward the outer periphery. In addition, even in a case where the beam diameter of the exposure beam is expanded by the first and second exposure optical systems 23 and 24, the Gaussian distribution is generated in the beam intensity of the exposure beam. Accordingly, in a case where reaction of the photopolymer is locally processed, since the stress applied about the center is increased, generation of distortion is increased.

Therefore, in the embodiment, the diffraction efficiency within a plane in the diffractive optic element 2 becomes uniform by suppressing local volume variation of the hologram recording material H in the exposure described above.

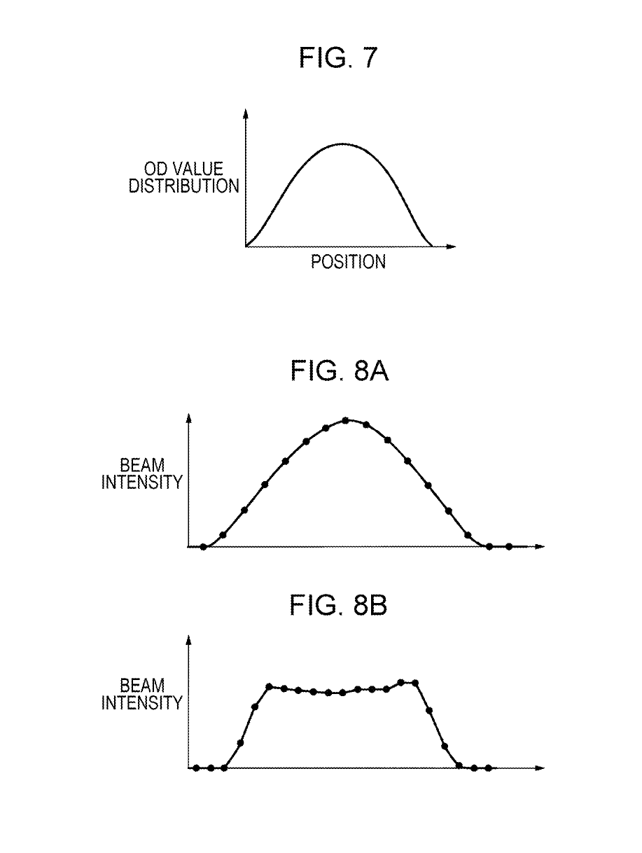

Specifically, in the method for manufacturing the diffractive optic element 2 according to the first embodiment, a neutral density (ND) filter (optical element) 40 is arranged in an optical path of one side or both sides of the object beam OB and the reference beam SB (both sides in the embodiment) in the exposure device illustrated in FIG. 4. As illustrated in FIG. 7, it is possible to use an apodizing ND filter having OD value distribution (concentration gradient) in which an optical density (OD) value in the vicinity of the center is higher than the OD value in the vicinity of the periphery, in the ND filter 40. In addition, in a case where the exposure beam is incident on the hologram recording material H in an oblique direction, since the Gaussian distribution of the exposure beam is lost, it is preferable to optimize the OD value distribution according to the loss.

As illustrated in FIG. 8A, beam intensity of the beam intensity distribution of the exposure beam before arranging the ND filter 40 is maximized in the vicinity of the center, and the beam intensity is decreased, as the beam intensity toward the outer periphery. With this, as illustrated in FIG. 8B, the beam intensity distribution of the exposure beam after arranging the ND filter 40 becomes flat (uniform) from the vicinity of the center toward the outer periphery.

With this, since the beam intensity of the exposure beam with which the hologram recording material H is irradiated becomes uniform, it is possible to uniformly process the reaction on the overall surface of the hologram recording material H. Accordingly, it is possible to obtain the diffractive optic element 2 in which the diffraction efficiency distribution is uniformly processed within a plane in the method for manufacturing the diffractive optic element in the embodiment.

### Second Embodiment

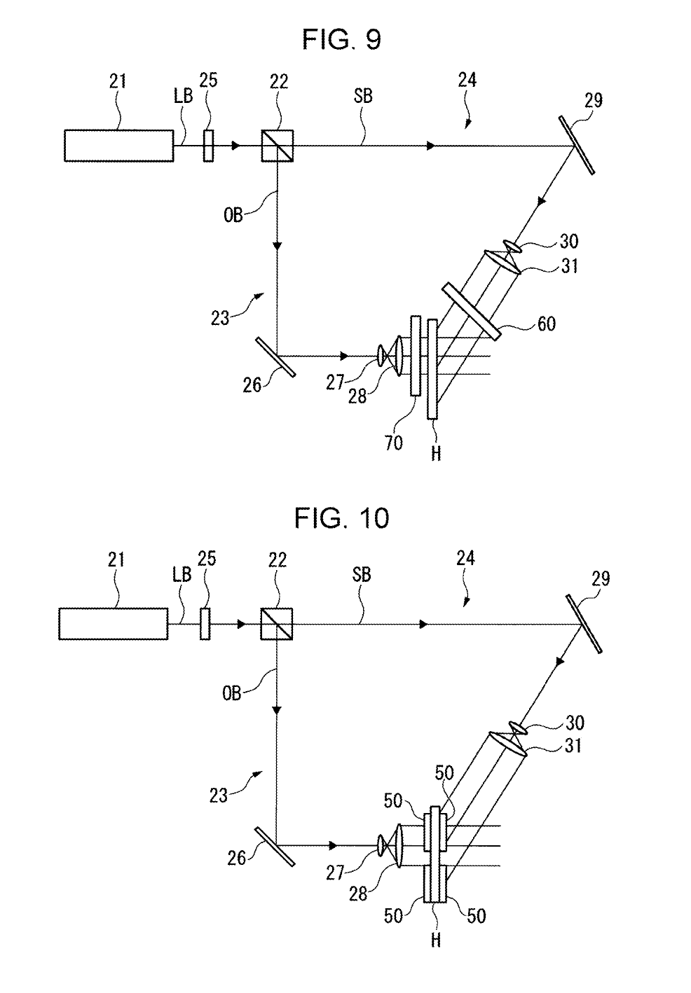

Next, a method for manufacturing the diffractive optic element 2 according to a second embodiment will be described with reference to FIG. 9. In addition, FIG. 9 is a schematic diagram illustrating a configuration of the exposure device used in the second embodiment. In addition, in the following description, explanation of the same parts as the exposure device illustrated in FIG. 4 is not repeated, and the same reference numerals are assigned in the drawings.

The method for manufacturing the diffractive optic element 2 according to the second embodiment includes exposure processing that exposes the hologram recording material H that is the diffractive optic element 2 by using the exposure device illustrated in FIG. 9. The exposure device illustrated in FIG. 9 has a configuration in which a spatial beam modulator (SLM) (optical element) 60 is arranged instead of the ND filter 40 in a beam path of the reference beam SB side, and a polarization element 70 is arranged in a beam path of the object beam OB side. Otherwise, the exposure device illustrated in FIG. 9 has the same configuration as the exposure device illustrated in FIG. 4.

It is possible to use, for example, a crystal element, as the spatial beam modulator 60. In a case where the spatial beam modulator 60 is used, since the beam intensity distribution of the exposure beam with which the hologram recording material H is irradiated is electrically adjusted, it is possible to cope with even complicated beam intensity distribution.

That is, in the exposure processing, OD value distributions of the ND filter 40 needed to equalize beam intensity are different all the time in a case where exposure conditions such as color reduction, exposure angle, and the like, are varied. Therefore, it is possible to finely adjust the concentration even under the same exposure conditions by using the spatial beam modulator capable of dynamically varying the OD value distribution (optical transmittance). In addition, even in a case of different exposure conditions, it is possible to equalize the beam intensity in one spatial beam modulator 60. Accordingly, it is possible to increase accuracy of uniformity of the beam intensity by using the high versatility spatial beam modulator 60.

A ½ wavelength (λ/2) plate is used in the polarization element 70 in order to align the polarization direction of the object beam OB and the reference beam SB. Since contrasts of the interference fringes become high by equalizing polarization directions of the reference beam SB and the object beam OB, it is possible to increase the diffraction efficiency of an exposed region, in the exposure beam. Meanwhile, it is possible to arrange the spatial beam modulator 60 in a beam path of both sides of the object beam OB and the reference beam SB, instead of the polarization element 70.

With this, since the beam intensity of the exposure beam with which the hologram recording material H is irradiated becomes uniform, it is possible to uniformly proceed the reaction on the overall surface of the hologram recording material H. Accordingly, it is possible to obtain the diffractive optic element 2 in which the diffraction efficiency distribution is uniformly processed within a plane in the method for manufacturing the diffractive optic element in the embodiment.

### Third Embodiment

Next, a method for manufacturing the diffractive optic element 2 according to a third embodiment will be described with reference to FIG. 10. In addition, FIG. 10 is a schematic diagram illustrating a configuration of the exposure device used in the third embodiment. In addition, in the following description, explanation of the same parts as the exposure device illustrated in FIG. 4 is not repeated, and the same reference numerals are assigned in the drawings.

The method for manufacturing the diffractive optic element 2 in the third embodiment includes exposure processing that exposes the hologram recording material H that is the diffractive optic element 2 by using the exposure device illustrated in FIG. 10. The exposure device illustrated in FIG. 10 has a configuration in which a beam blocking plate 50 is arranged instead of the ND filter 40. Otherwise, the exposure device illustrated in FIG. 10 has the same configuration as the exposure device illustrated in FIG. 4.

That is, the method for manufacturing the diffractive optic element 2 according to the embodiment divides an exposure region of the hologram recording material H that is exposed by the exposure beam into regions equal to or greater than two, and performs exposure on every exposure region that is divided. In this case, an exposure region other than the exposure region in which the exposure is selected among the divided exposure region equal to or greater than two is blocked by the beam blocking plate 50. In addition, in a case where the divided exposure region is exposed, regions blocked by the beam blocking plate 50 do not overlap with each other are implemented so that generation of a region that is not exposed is suppressed.

In the method for manufacturing the diffractive optic element 2 according to the embodiment, since an exposure condition in every exposure region that is divided can be adjusted according to the beam intensity distribution of the exposure beam by dividing the exposure region of the hologram recording material H exposed by the exposure beam, it is possible to uniformly proceed the diffraction efficiency distribution within a plane. For example, it is possible to reduce the influence of the beam intensity distribution of the exposure beam by adjusting the exposure time according to the beam intensity such that the exposure time becomes short in a region in which the beam intensity of the exposure beam is strong and the exposure time becomes long in a region in which the beam intensity of the exposure beam is weak. In addition, it is possible to decrease a difference of the beam intensity within the divided exposure region than in a case where the overall of exposure region is exposed by dividing the exposure region.

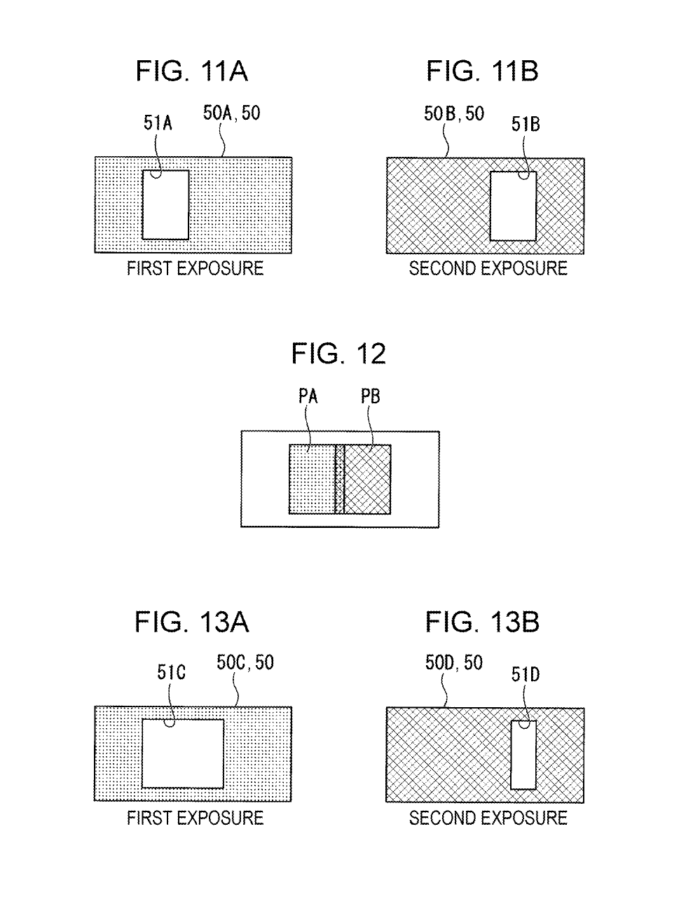

Here, as the beam blocking plate 50, for example, a case where the exposure is performed in every exposure regions PA and PB of which are divided into two regions illustrated in FIG. 12 by using two beam blocking plates 50A and 50B illustrated in FIGS. 11A and 11B will be described.

First, first exposure is performed by using the beam blocking plate 50A with respect to one exposure region PA among the exposure regions PA and PB that are divided into two regions. The beam blocking plate 50A includes an opening portion 51A corresponding to one exposure region PA, and is arranged to block the other exposure region PB.

Next, second exposure is performed by using the beam blocking plate 50B with respect to the other exposure region PB among the exposure regions PA and PB that are divided into two regions. The beam blocking plate 50B includes an opening portion 51B corresponding to the other exposure region PB, and is arranged to block one exposure region PA.

The second exposure is processed such that a region blocked by the beam blocking plate 50B is not overlapped with a region blocked by the beam blocking plate 50A in the first exposure. In this case, the exposure region PA in the first exposure and the exposure region PB in the second exposure are not supposed to be overlapped in a boundary region PC therebetween, but become a state where the regions are exposed in a multiple exposure manner, as the exposure beam is slightly formed on the region side that is blocked by the diffraction of the exposure beam.

With this, it is possible to adjust the exposure time in every exposure region that is divided of the hologram recording material H, and to make the beam intensity distribution on the overall exposure region uniform. Accordingly, in the manufacturing method of the embodiment, it is possible to obtain the diffractive optic element 2 in which the diffraction efficiency distribution is uniformly processed within a plane. Particularly, in a case where the beam intensity distribution of the exposure beam is large, it is possible to obtain an effect such as the diffraction efficiency distribution is uniformly processed within a plane on the overall area of the exposure region of the hologram recording material H, by performing the division of the exposure region described above, and by decreasing each exposure region that is divided.

In addition, in a method for dividing the exposure region of the hologram recording material H, the exposure may be performed by using, for example, the beam blocking plates 50C and 50D illustrated in FIGS. 13A and 13B without being limited to a case of performing the exposure by using the beam blocking plates 50A and 50B illustrated in FIGS. 11A and 11B described above. That is, areas of the opening portions 51A and 51B are the same in the beam blocking plates 50A and 50B illustrated in FIGS. 11A and 11B. However, areas of the opening portions 51C and 51D are different from each other in the beam blocking plates 50C and 50D illustrated in FIGS. 13A and 13B. In this case, it is possible to vary areas of the exposure region on every exposure.

For example, in a case of the exposure beam (spherical wave) with which the hologram recording material H is obliquely irradiated, even when the beam intensity distribution of the exposure beam is uniform, a gradient in the beam intensity distribution is generated on an exposure surface of the hologram recording material H. In this case, the beam intensity may become strong rapidly at the end portion of the exposure surface of the hologram recording material H, depending on positions of converging points of the spherical wave.

Therefore, only a region with strong beam intensity is divided into small regions, and the exposure is performed while adjusting the exposure time with respect to the divided regions, by using the beam blocking plates 50C and 50D illustrated in FIGS. 13A and 13B. With this, it is possible to effectively reduce an effect caused by the beam intensity gradient.

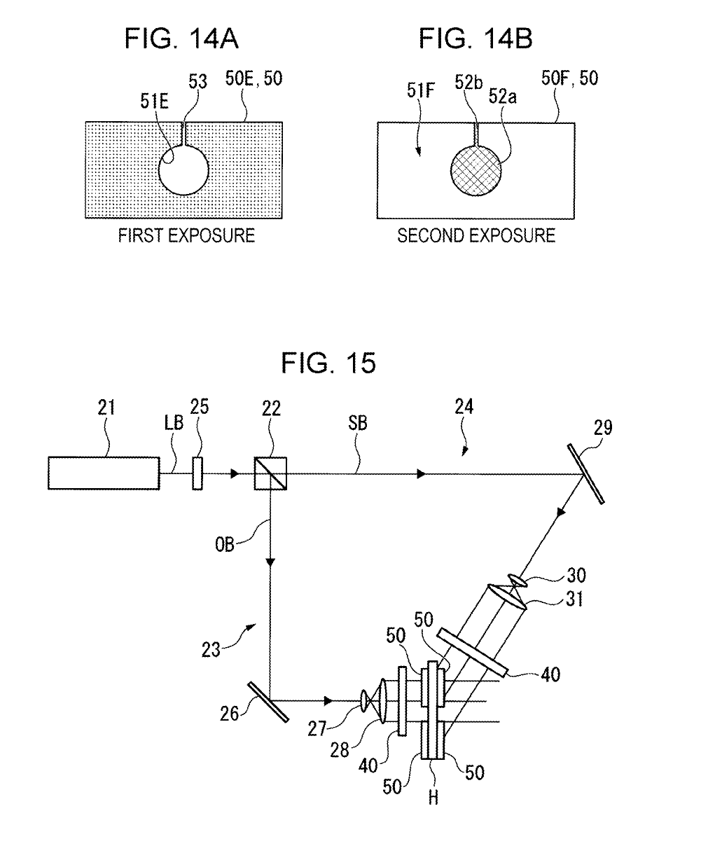

In addition, the beam blocking plate 50 may be a shape other than a rectangular shape, such as beam blocking plates 50E and 50F, for example, illustrated in FIGS. 14A and 14B, without being limited to a shape of the rectangular opening portions 51A, 51B, 51C, and 51D, such as the beam blocking plates 50A, 50B, 50C, and 50D, described above.

Specifically, the beam blocking plate 50E of FIG. 14A includes an opening portion 51E with a circular shape in the center. Meanwhile, the beam blocking plate 50F illustrated in FIG. 14B includes a rectangular frame shape opening portion 51F that is formed by a circular beam blocking portion 52a corresponding to the opening portion 51E at the center thereof. In addition, the beam blocking portion 52a is connected with the frame shape portion of the beam blocking plate 50F via a linear connecting portion 52b. Meanwhile, a linear slit 53 corresponding to a connecting portion 52b is continuously provided to the opening portion 51E in the beam blocking plate 50E.

For example, in a case of spherical wave exposure, a tendency is observed that the beam intensity of the center of the exposure beam becomes strong, as it gets closer to the converging point. In this case, the center region of the hologram recording material H and the outer region thereof are divided by using the beam blocking plates 50E and 50F illustrated in the FIGS. 14A and 14B, and the exposure time is adjusted in every divided region. With this, it is possible to effectively reduce the effect of the beam intensity gradient.

### Fourth Embodiment

Next, a method for manufacturing the diffractive optic element 2 according to a fourth embodiment will be described with reference to FIG. 15. In addition, FIG. 15 is a schematic diagram illustrating a configuration of the exposure device using a fourth embodiment. In addition, in the following description, explanation of the same parts as the exposure device illustrated in FIG. 4 is not repeated, and the same reference numerals are assigned in the drawings.

The method for manufacturing the diffractive optic element of the fourth embodiment includes exposure processing that exposes the hologram recording material H that is the diffractive optic element 2 by using the exposure device illustrated in FIG. 15. The exposure device illustrated in FIG. 15 has a configuration where the beam blocking plate 50 illustrated in the above FIG. 10 is arranged in addition to the configuration of the exposure device illustrated in FIG. 4. Therefore, in the method for manufacturing the diffractive optic element of the fourth embodiment, the exposure region of the hologram recording material H that is exposed by the exposure beam is divided into regions equal to or greater than two, and the exposure is performed in every divided exposure region.

That is, the method for manufacturing the diffractive optic element of the fourth embodiment is a combined method of uniform exposure of beam intensity of the exposure beam by the method for manufacturing the diffractive optic element of the first embodiment and the division exposure by the method for manufacturing the diffractive optic element of the third embodiment.

Specifically, in the method for manufacturing the diffractive optic element of the embodiment, first, the first exposure is performed with respect to the center portion of the hologram recording material H by using the beam blocking plate 50E illustrated in FIG. 14A, as the beam blocking plate 50. At this time, since the beam intensity of the laser beam LB has Gaussian distribution in the center of the exposure beam, the exposure intensity is rapidly varied. Therefore, the beam intensity distribution of the exposure beam is uniformly processed by using an ND filter 4 in the first exposure.

Next, the second exposure is performed with respect to the peripheral of the hologram recording material H by using the beam blocking plate 50F illustrated in FIG. 14B, as the beam blocking plate 50. At this time, since variation of the beam intensity is moderate in the peripheral of the exposure beam, the beam intensity is also weak. Therefore, the beam of the peripheral of the exposure beam is effectively used without arranging the ND filter 40 in the second exposure.

With this, it is possible to uniformly proceed a reaction on the overall surface of the hologram recording material H by uniformly proceeding the beam intensity of the exposure beam with which the hologram recording material H is irradiated. Accordingly, in the method for manufacturing the diffractive optic element of the embodiment, it is possible to obtain the diffractive optic element 2 in which the diffraction efficiency distribution is uniformly processed within a plane.

### Fifth Embodiment

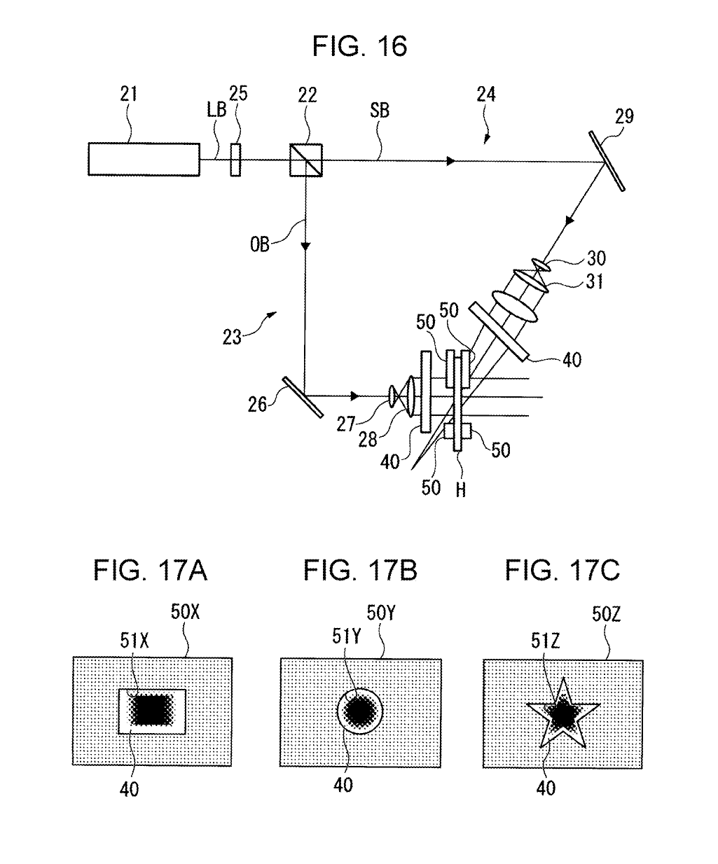

Next, a method for manufacturing the diffractive optic element 2 according to a fifth embodiment will be described with reference to FIG. 16. In addition, FIG. 16 is a schematic diagram illustrating a configuration of the exposure device using the fifth embodiment. In addition, in the following description, explanation of the same parts as the exposure device illustrated in FIG. 4 is not repeated, and the same reference numerals are assigned in the drawings.

The method for manufacturing the diffractive optic element of the fifth embodiment includes exposure processing that exposes the hologram recording material H that is the diffractive optic element 2 by using the exposure device illustrated in FIG. 16. The exposure device illustrated in FIG. 16 has the same configuration as the exposure device illustrated in FIG. 15. However, there is a case where one (reference beam SB in the embodiment) of the object beam OD and the reference beam SB is a spherical wave, and the spherical wave is obliquely incident on the hologram recording material H.

In this case, since the beam intensity of the spherical wave becomes strong, as it gets closer to the converging point, the strongest region of the beam intensity on the exposure surface of the hologram recording material H is not limited to the center portion of the hologram recording material H. Therefore, exposure is performed by dividing the region into the strongest region of the beam intensity and a region except the strongest region by using the beam blocking plates 50C and 50D illustrated in FIGS. 13A and 13B, as the beam blocking plate 50.

Meanwhile, it is preferable to use an OD value distribution for oblique incidence in which an OD value is continuously varied from the end portion, other than distribution of a concentric OD value corresponding to the Gaussian distribution, in the ND filter 40.

With this, it is possible to uniformly proceed a reaction on the overall surface of the hologram recording material H by uniformly proceeding the beam intensity of the exposure beam with which the hologram recording material H is irradiated. Accordingly, in the method for manufacturing the diffractive optic element of the embodiment, it is possible to obtain the diffractive optic element 2 in which the diffraction efficiency distribution is uniformly processed within a plane.

In addition, the disclosure is not intended to be necessarily limited to the above embodiments, and it is possible to implement various modifications without departing from the scope of the disclosure.

For example, a case where diffraction efficiency is uniform on the overall exposure region within a plane of the diffractive optic element 2 is described in the embodiment. However, only the required regions may be processed in uniform diffraction efficiency.

In this case, it is possible to perform the exposure by blocking the beam in a region in which the exposure is not required according to utilization, such as the ND filter 40 blocked by a beam blocking plate 50X having a rectangular opening portion 51X as illustrated in FIG. 17A, the ND filter 40 blocked by a beam blocking plate 50Y having a circle opening portion 51Y as illustrated in FIG. 17B, the ND filter 40 blocked by a beam blocking plate 50Z having a star opening portion 51Z, as illustrated in FIG. 17C, and the like.

In a case where the exposure region of the hologram recording material H described above is divided into regions equal to or greater than two, and the exposure is performed on every divided exposure region, it is preferable that the exposure is first performed in the center portion rather than the peripheral portion of the hologram recording material H, as an order of performing the exposure of the exposure region that is divided.

For example, in a case where the diffractive optical element having a large display region of the visual field is manufactured, when the peripheral portion of the hologram recording material H is first exposed, material of the peripheral portion is first expanded (or contracted) by the reaction of the hologram recording material H. In this case, not only is force acting in the direction of the outer periphery of the hologram recording material H generated, but also force in which the hologram recording material H is exerted in the direction of the center that is not reacted is generated. With this, since there is no place for the force in the center portion of the hologram recording material H to escape, distortion is generated. As a result, a state of the center portion of the hologram recording material H that is not reacted becomes a state where distortion has been generated before the exposure.

In this state, when the center portion of the hologram recording material H is exposed by the second divided exposure, in a state in which distortion is generated in the material, volume variation is further generated by the reaction of the material. Therefore, variation is generated in the interference fringes of the hologram recorded in reaction processing, and a reduction of diffraction efficiency is generated in the center portion of the hologram recording material H in which a hologram different from a design is recorded.

Accordingly, the exposure is first performed in the center portion rather than the peripheral portion of the hologram recording material H. It is possible to reduce the occurrence of distortion, and suppress a reduction in the diffraction efficiency while suppressing forces, in which there is no place to escape, acting in the direction of the center, by dispersing the distortion due to volume variation caused by reaction of the hologram recording material H in the peripheral portion.

Meanwhile, in the embodiment, it is possible to perform the exposure on the peripheral portion first rather than the center portion of the hologram recording material H. In this case, the distortion of the center portion of the hologram recording material H is intentionally increased, and the diffraction efficiency of the center portion of the hologram recording material H is decreased by first exposing the peripheral portion rather than the center portion of the hologram recording material H. With this, it is possible to obtain the diffractive optic element of which the diffraction efficiency is low in the center portion.

The entire disclosure of Japanese Patent Application No. 2015-089289, filed Apr. 24,2015 is expressly incorporated by reference herein.

What is claimed is:

1. A method for manufacturing a diffractive optic element by exposing hologram recording material, the method comprising:
exposure processing that divides a coherent beam radiated from a beam source into an object beam and a reference beam, and irradiates the hologram recording material with an exposure beam by interfering the object beam with the reference beam,
wherein, in the exposure processing, an optic element, which adjusts beam intensity distribution of the exposure beam with which the hologram recording material is irradiated, is arranged in a path of the object beam or the reference beam.

2. The method for manufacturing the diffractive optic element according to claim 1,
wherein a neutral density filter is used as the optic element.

3. The method for manufacturing the diffractive optic element according to claim 1,
wherein a spatial beam modulator is used as the optic element.

4. The method for manufacturing the diffractive optic element according to claim 2,
wherein, in the exposure processing, the spatial beam modulator is arranged in a path of one side of the object beam and the reference beam, and a polarization element is arranged in the path of the other side.

5. The method for manufacturing the diffractive optic element according to claim 1,
wherein, in the exposure processing, an exposure region of the hologram recording material is divided into a plurality of regions, and the exposure is performed to each of the plurality of regions.

6. The method for manufacturing the diffractive optic element according to claim 5,
wherein, in the exposure processing, an exposure region except a region where the exposure is selected among the plurality of regions is blocked.

7. A method for manufacturing a diffractive optic element by exposing hologram recording material, the method comprising:
exposure processing that divides a coherent beam radiated from a beam source into an object beam and a reference beam, and irradiates the hologram recording material with an exposure beam by interfering the object beam with the reference beam,
wherein, in the exposure processing, the hologram recording material exposed by the exposure beam is divided into a plurality of regions, and the exposure is performed to each of the plurality of regions.

8. The method for manufacturing the diffractive optic element according to claim 7,
wherein, in the exposure processing, an exposure region except a region where the exposure is selected among the plurality of regions is blocked.

9. An image display device comprising:
an image beam generation unit that generates an image beam; and
a diffractive optic element that deflects toward eyes of a user at least a part of the image beam,
wherein the diffractive optic element uses the diffractive optic element manufactured by using the method for manufacturing the diffractive optic element according to claim 1.

10. An image display device comprising:
an image beam generation unit that generates an image beam; and
a diffractive optic element that deflects toward eyes of a user at least a part of the image beam,
wherein the diffractive optic element uses the diffractive optic element manufactured by using the method for manufacturing the diffractive optic element according to claim 2.

11. An image display device comprising:
an image beam generation unit that generates an image beam; and
a diffractive optic element that deflects toward eyes of a user at least a part of the image beam,
wherein the diffractive optic element uses the diffractive optic element manufactured by using the method for manufacturing the diffractive optic element according to claim 3.

12. An image display device comprising:
an image beam generation unit that generates an image beam; and
a diffractive optic element that deflects toward eyes of a user at least a part of the image beam,
wherein the diffractive optic element uses the diffractive optic element manufactured by using the method for manufacturing the diffractive optic element according to claim 4.

13. An image display device comprising:
an image beam generation unit that generates an image beam; and
a diffractive optic element that deflects toward eyes of a user at least a part of the image beam,
wherein the diffractive optic element uses the diffractive optic element manufactured by using the method for manufacturing the diffractive optic element according to claim 5.

14. An image display device comprising:
an image beam generation unit that generates an image beam; and
a diffractive optic element that deflects toward eyes of a user at least a part of the image beam,
wherein the diffractive optic element uses the diffractive optic element manufactured by using the method for manufacturing the diffractive optic element according to claim 6.

15. An image display device comprising:
an image beam generation unit that generates an image beam; and
a diffractive optic element that deflects toward eyes of a user at least a part of the image beam,
wherein the diffractive optic element uses the diffractive optic element manufactured by using the method for manufacturing the diffractive optic element according to claim 7.

16. An image display device comprising:
an image beam generation unit that generates an image beam; and
a diffractive optic element that deflects toward eyes of a user at least a part of the image beam,
wherein the diffractive optic element uses the diffractive optic element manufactured by using the method for manufacturing the diffractive optic element according to claim 8.
